(19) United States
(12) Patent Application Publication
(10) Pub. No.: US 2017/0324853 A1
(43) Pub. Date: Nov. 9, 2017

(54) APPARATUS FOR STORING AND DEPLOYING A CELL PHONE

(71) Applicant: FORD GLOBAL TECHNOLOGIES, LLC, Dearborn, MI (US)

(72) Inventors: Shivraj Karthik Ranganathan, Canton, MI (US); Manjil M. Kale, Livonia, MI (US); Robert Michael Coury, Belleville, MI (US)

(21) Appl. No.: 15/146,576

(22) Filed: May 4, 2016

(51) Int. Cl. H04M 1/04; H04B 1/3883

(52) U.S. Cl. CPC H04M 1/04; H04B 1/3883

(57) ABSTRACT

An apparatus is provided for storing and deploying a cell phone. That apparatus includes a guide track and a carriage displaceable along the guide track between a storage position and a deployed position. A drive element displaces the carriage between the two positions and a damping mechanism ensures that the carriage moves with a smooth and consistent motion along the guide track.

### TECHNICAL FIELD

This document relates generally to the motor vehicle equipment field and, more particularly, to an apparatus for storing and deploying a cell phone that may be fully and seamlessly integrated into the interior of a motor vehicle.

### BACKGROUND

The use of cell phones and smart phones by the consuming public is wide spread. Cell phones and cell phone charging cables are currently the two most commonly carried items by users of motor vehicles. Thus, providing consumers with a modular storage feature that is easily accessible to occupants of the vehicle is a very important step towards embracing global technology.

A large percentage of the cell phone storage solutions that are offered today are aftermarket and do not integrate seamlessly into the motor vehicle environment. Studies have indicated that the drivers who use their devices in motor vehicles rate the front row cup holders in the center console as a preferred device storage location even if alternate compartments are provided.

This document relates to a new and improved apparatus dedicated to storing and deploying a cell phone from many drivers' most desired location in a motor vehicle. The apparatus includes a retractable cell phone tray that conveniently holds the cell phone at a desired angle when in a deployed position and is also easily retracted into a storage position where the cell phone is hidden within the center console. Advantageously, the apparatus also supports integrated wireless inductive charging of smart phone devices through an inductive charging module.

### SUMMARY

In accordance with the purposes and benefits described herein, an apparatus is provided for storing and deploying a cell phone. That apparatus comprises a guide track, a carriage displaceable along the guide track between a storage position and a deployed position and a drive element. The drive element displaces the carriage from the storage position to the deployed position. In addition, a damping mechanism is provided to ensure that the carriage moves along the guide track with a smooth motion.

The damping mechanism may include a first gear rack carried on the guide track and a first pinion mounted for rotation on the carriage. Further, the damping mechanism may include a second gear rack carried on the guide track and a second pinion mounted for rotation on the carriage. The second gear rack may be opposed to the first gear rack.

The carriage may include a cell phone tray that receives and holds the cell phone. That cell phone tray may include an inductive cell phone charger so that a smart cell phone may be charged in both the storage position and the deployed position. The cell phone tray may also include an integral angled cover. The integral angled cover may fit flush with a surface of a center console of a motor vehicle when the carriage is in the storage position.

The drive element may comprise a spring such as a constant force spring. That constant force spring may be connected at a first end to the guide track and at a second end to the carriage.

Still further, the apparatus may include a push-push locking mechanism for locking the carriage in the storage position.

Stated another way, the apparatus for storing and deploying a cell phone may comprise a guide track, a carriage displaceable along the guide track between a storage position and a deployed position and a spring for displacing the carriage from the storage position to the deployed position. Further, the apparatus may include a push-push locking mechanism for locking the carriage in a storage position.

In such an embodiment, the spring may comprise a constant force spring having a first end connected to the guide track and a second end connected to the carriage.

In the following description, there are shown and described several preferred embodiments of the apparatus for storing and deploying a cell phone. As it should be realized, the apparatus is capable of other, different embodiments and its several details are capable of modification in various, obvious aspects all without departing from the apparatus as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the apparatus and together with the description serve to explain certain principles thereof. In the drawing figures:

FIG. 1 is a detailed front perspective view of the apparatus for storing and deploying a cell phone showing the carriage of that apparatus in the storage position.

FIG. 1a is a detailed rear perspective view of the drive element and damping mechanism of the apparatus illustrated in FIG. 1 shown in the storage position.

FIG. 2 is a view similar to FIG. 1 but showing the carriage of the apparatus in the deployed position.

FIG. 2a is a detailed rear perspective view of the drive element and damping mechanism of the apparatus shown in the deployed position.

FIG. 3 is a schematic cross-sectional view of the apparatus shown in the storage position.

FIG. 4 is a detailed plan view illustrating the details of the drive element and the damping mechanism of the apparatus.

FIG. 5 is a schematic cross-sectional view through the slider showing how the opposed lugs of the slider are received in channels in the rails while the pinions carried on the slider engage the teeth of the two gear racks.

Reference will now be made in detail to the present preferred embodiments of the apparatus for storing and deploying a cell phone, examples of which are illustrated in the accompanying drawing figures.

### DETAILED DESCRIPTION

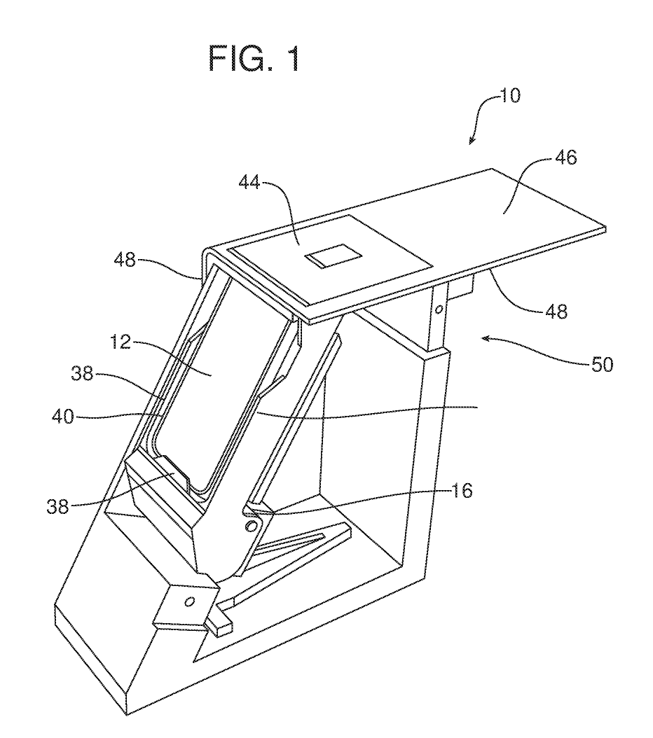

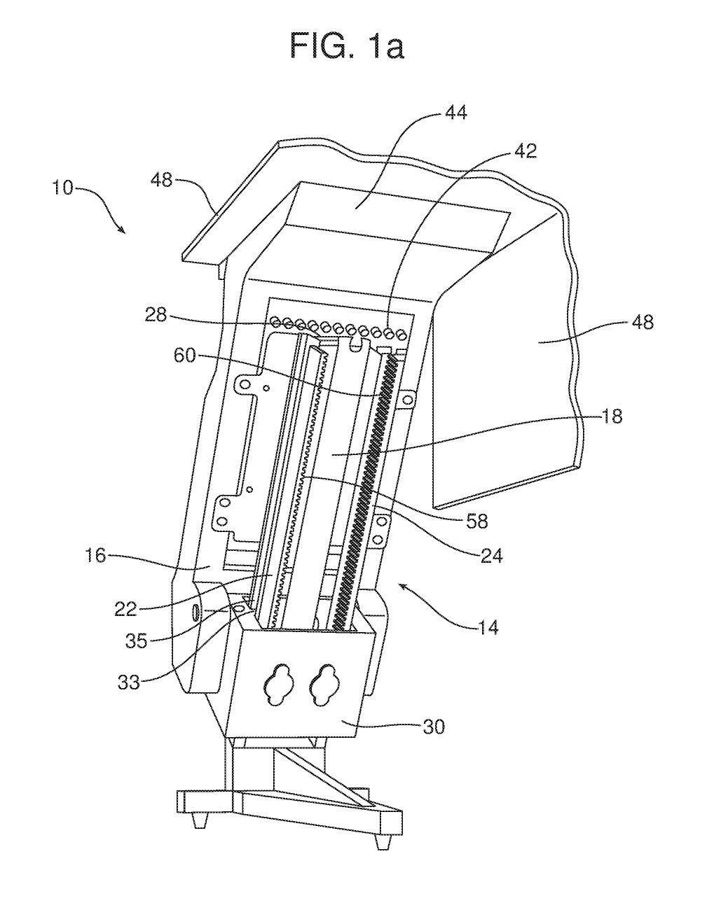

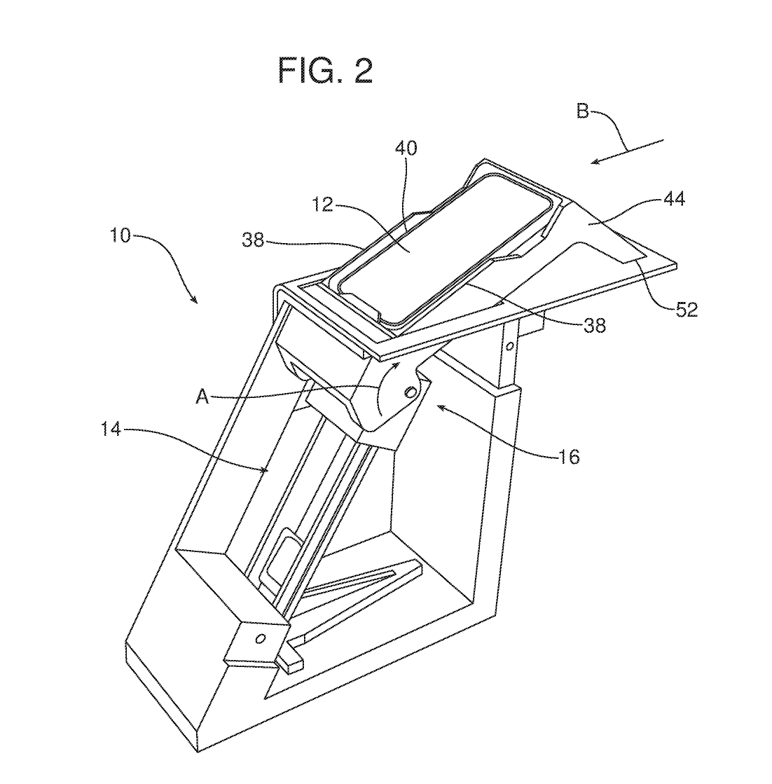

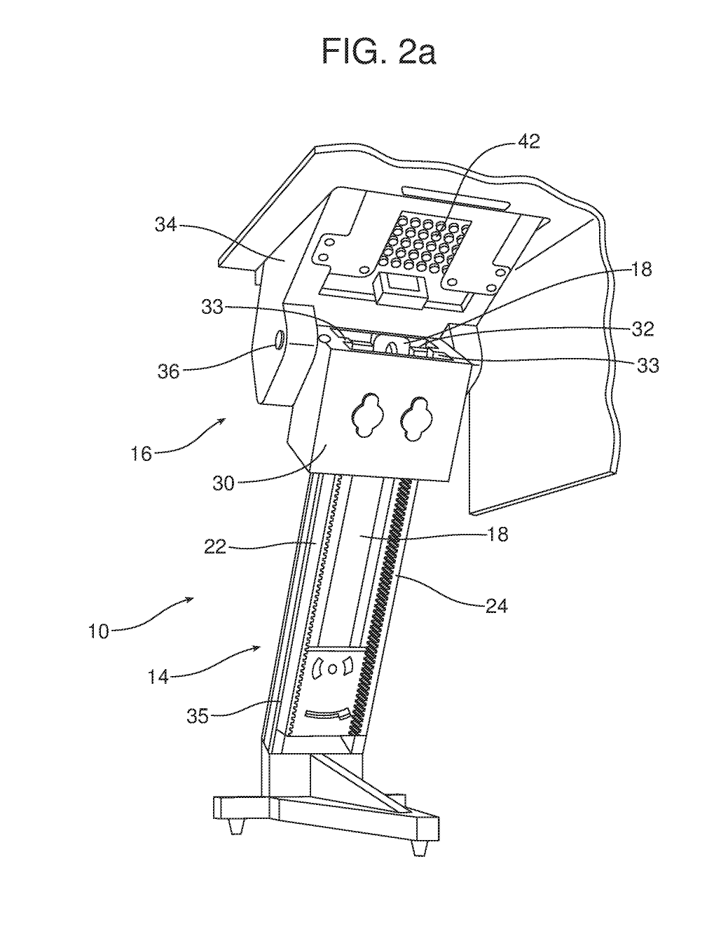

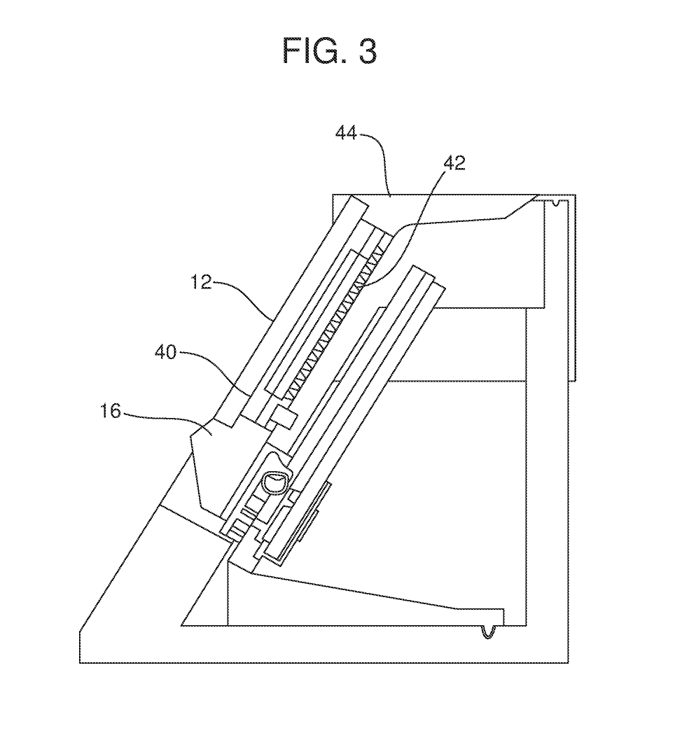

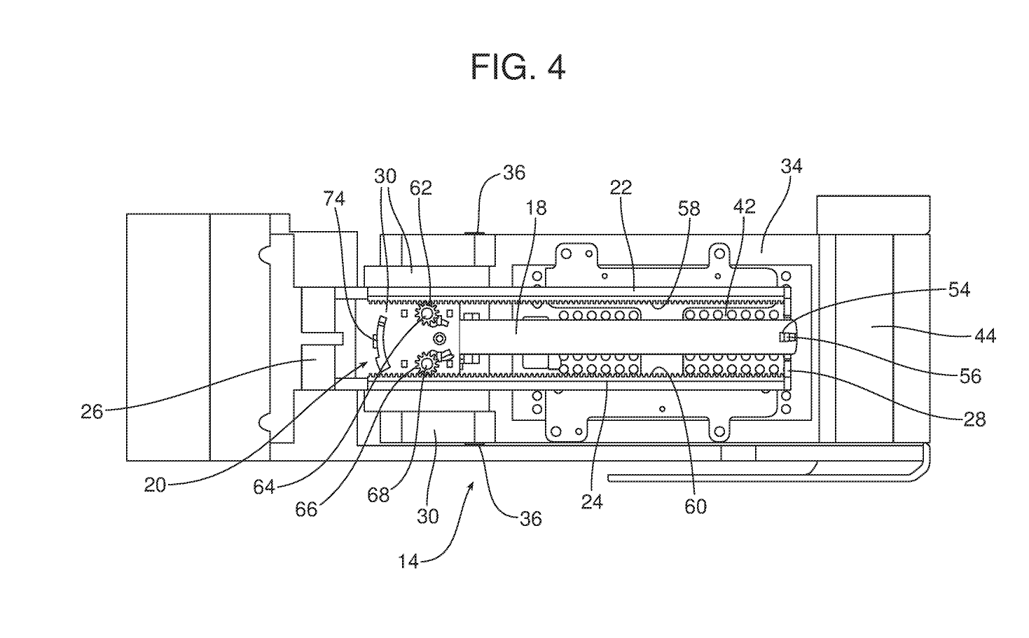

Reference is now made to FIGS. 1-5 illustrating the apparatus 10 for storing and deploying a cell phone 12. That apparatus 10 may be broadly described as including a guide track, generally designated by reference numeral 14. The apparatus 10 may also include a carriage 16 that is displaceable along the guide track 14 between a storage position illustrated in FIGS. 1 and 1a and a deployed position illustrated in FIGS. 2 and 2a. Further, the apparatus 10 includes a drive element 18 for displacing the carriage 16 from the storage position to the deployed position and a damping mechanism 20 to provide smooth motion of the carriage 16 along the guide track 14.

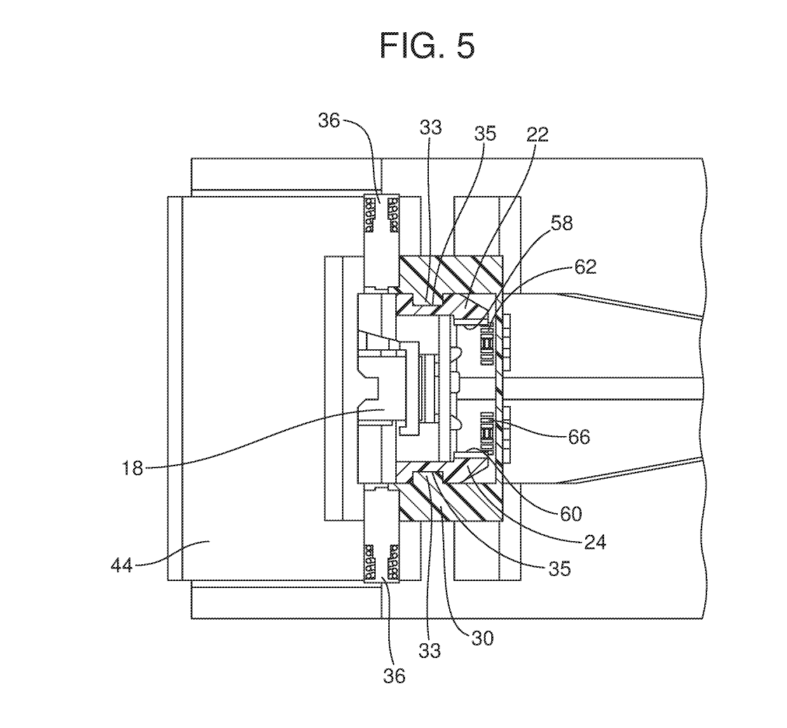

More specifically, the guide track 14 comprises two opposed rails 22, 24 and two cross-members 26, 28 that are fixed to the console or other support structure. The carriage 16 includes a slider 30 that is generally rectangular in shape and has a central opening 32 so that the slider may be received over the guide track 14 with the opposed lugs 33 on the slider sliding along outwardly opening channels 35 in the two rails 22, 24. See FIG. 5.

In addition, the carriage 16 includes a cell phone tray 34 that is pivotally connected by pins (bistable hinges) 36 to the slider 30. As best illustrated in FIGS. 1 and 2, the cell phone tray 34 includes features/flanges 38 defining a cell phone receiving cavity 40 on the front face of the cell phone tray 34. The features 38 and cavity 40 function to securely hold cell phones of various sizes on the cell phone tray 34 when in the storage position, the deployed position or being displaced between those two positions.

An inductive cell phone charger 42 is carried on the rear face of the cell phone tray 34 (see FIGS. 1a, 2a, 3 and 4). This inductive cell phone charger 42 functions to wirelessly charge smart cell phones at all times, including when the carriage 16 is in the storage position, the carriage 16 is in the deployed position or the carriage is being displaced between those two positions.

As illustrated in FIGS. 1 and 2, the carriage 16 also includes an integral angled cover 44. When the carriage 16 is in the storage position, the integral angled cover 44 fits flush with the surface 46 of the center console 48 of the motor vehicle so as to provide an aesthetically pleasing appearance. As should be appreciated, the carriage 16 and cell phone 12 are stored in the compartment 50 within the center console 48 where they are concealed from view.

As best illustrated in FIG. 2, the integral angled cover 44 also includes a beveled support 52. As the carriage 16 is displaced from the storage position illustrated in FIG. 1 to a deployed position illustrated in FIG. 2, the cell phone tray 34 pivots forward about the pins 36 in the direction of action arrow A until the beveled support 52 engages the upper surface 46 of the center console 48 thereby supporting the cell phone 12 and the cell phone tray 34 at an advantageous viewing angle for the driver of the motor vehicle.

As best illustrated in FIGS. 1a, 2a and 4, the drive element 18 in the illustrated embodiment comprises a spring and, more particularly, a constant force spring. As illustrated, the constant force spring 18 is connected at a first end to the cross-member 28 of the guide track 14. Note, particularly, the aperture 54 at the first end of the constant force spring 18 received over the mounting lug 56 carried on the cross member 28.

The damping mechanism 20 includes a first gear rack 58 carried on the rail 22 and a second, opposed gear rack 60 carried on the rail 24. A first pinion 62 is mounted by stub shaft 64 to the slider 30. Similarly, a second pinion 66 is mounted a stub shaft 68 to the slider 30. The first pinion 62 engages with the teeth of the first gear rack 58 while the second pinion 66 engages with the teeth of the second rack 60.

A push-push locking mechanism 74 of a type known in the art functions to lock the carriage 16 in the storage position illustrated in FIG. 1.

When one wishes to deploy the carriage 16 in order to gain access to the cell phone 12 held on the cell phone tray 34 and concealed in the compartment 50 within the center console 48, one pushes down on the cover 44 and then releases the cover. This unlatches the locking mechanism 74 and allows the constant force spring 18 to drive the carriage 16 from the storage position illustrated in FIG. 1 toward the fully deployed position illustrated in FIG. 2. During this movement, the pinions 62, 66 rotate on the stub shafts 64, 68 and travel along the respective gear racks 58, 60. As this is done, the pinions 62, 66 mesh with the teeth of those gear racks 58, 60 to ensure that the carriage 16 is deployed with a smooth motion.

As the carriage 16 rises toward the deployed position, the weight of the cell phone tray 34 and the cell phone 12 causes the cell phone tray 34 to pivot forward about the pivot pins 36 until the carriage reaches the fully deployed position and the beveled support 52 at the end of the integral angled cover 44 engages and rests on the top surface 46 of the center console 48 as illustrated in FIG. 2.

When one subsequently wishes to displace the carriage 16 from the deployed position back to the stowed position illustrated in FIG. 1, one pushes in the direction of action arrow B on the top of the cover 44. As the carriage 16 travels down along the guide track 14, the cell phone tray 34 pivots about the pivot pins 36 to bring the cover 44 into proper orientation for a flush fit with the top surface 46 of the center console 48 upon reaching the storage position. At that point the locking mechanism 74 again engages to lock the carriage 16 in place.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. An apparatus for storing and deploying a cell phone, comprising:
a guide track;
a carriage displaceable along said guide track between a storage position and a deployed position, said carriage including a cell phone tray that receives and holds the cell phone and an inductive cell phone charger carried on a rear face of the cell phone tray;
a drive element displacing said carriage from said storage position to said deployed position; and
a damping mechanism to provide smooth motion of said carriage along said guide track.

2. The apparatus of claim 1, wherein said damping mechanism includes a first gear rack carried on said guide track and a first pinion mounted for rotation on said carriage.

3. The apparatus of claim 2, wherein said damping mechanism includes a second gear rack carried on said guide track and a second pinion mounted for rotation on said carriage.

4. The apparatus of claim 3, wherein said second gear rack is opposed to said first gear rack.

5. (canceled)

6. (canceled)

7. The apparatus of claim 4, wherein said drive element comprises a constant force spring.

8. The apparatus of claim 7, wherein said constant force spring is connected at a first end to said guide track and at a second end to said carriage.

9. The apparatus of claim 8, further including a push-push locking mechanism for locking said carriage in said storage position.

10. The apparatus of claim 9, wherein said cell phone tray includes an integral angled cover and said integral angled cover fits flush with a surface of a center console of a motor vehicle when said carriage is in said storage position.

11. (canceled)

12. (canceled)

13. The apparatus of claim 1, wherein said cell phone tray includes an integral angled cover and said integral angled cover fits flush with a surface of a center console of a motor vehicle when said carriage is in said storage position.

14. The apparatus of claim 1, wherein said drive element comprises a constant force spring.

15. The apparatus of claim 14, wherein said constant force spring has a first end connected to said guide track and a second end connected to said carriage.

16. The apparatus of claim 15, further including a push-push locking mechanism for locking said carriage into said storage position.

17. The apparatus of claim 16, wherein said cell phone tray includes an integral angled cover and said integral angled cover fits flush with a surface of a center console of a motor vehicle when said carriage is in said storage position.

18. The apparatus of claim 1, including a push-push locking mechanism for locking said carriage in said storage position.

19. An apparatus for storing and deploying a cell phone, comprising:
a guide track;
a carriage displaceable along said guide track between a storage position and a deployed position, said carriage including a releasable angled cover;
a spring displacing said carriage from said storage position to said deployed position; and
a push-push locking mechanism for locking said carriage in said storage position.

20. The apparatus of claim 19, wherein said spring comprises a constant force spring having a first end connected to said guide track and a second end connected to said carriage.

21. The apparatus of claim 19, wherein the releasable angled cover includes a beveled support for engaging an upper surface of a center console of a motor vehicle when said carriage is in said deployed position.
